(19) United States
(12) Patent Application Publication
(10) Pub. No.: US 2015/0078550 A1
(43) Pub. Date: Mar. 19, 2015

(54) SECURITY PROCESSING UNIT WITH CONFIGURABLE ACCESS CONTROL

(71) Applicant: Microsoft Corporation, Redmond, WA (US)

(72) Inventors: Niels T. Ferguson, Redmond, WA (US); Dave M. McPherson, Bothell, WA (US); Mark Fishel Novak, Newcastle, WA (US); Paul England, Bellevue, WA (US)

(73) Assignee: Microsoft Corporation, Redmond, WA (US)

(21) Appl. No.: 14/230,918

(22) Filed: Mar. 31, 2014

Related U.S. Application Data
(60) Provisional application No. 61/877,823, filed on Sep. 13, 2013.

(51) Int. Cl. H04L 9/08

(52) U.S. Cl. CPC H04L 9/0861
USPC 380/44

(57) ABSTRACT

A security processing unit is configured to manage cryptographic keys. In some instances, the security processing unit may comprise a co-processing unit that includes memory, one or more processors, and other components to perform operations in a secure environment. A component that is external to the security processing unit may communicate with the security processing unit to generate a cryptographic key, manage access to a cryptographic key, encrypt/decrypt data with a cryptographic key, or otherwise utilize a cryptographic key. The external component may comprise a central processing unit, an application, and/or any other hardware or software component that is located outside the security processing unit.

### RELATED APPLICATIONS

This application claims the benefit of U.S. Provisional Application No. 61/877,823, filed Sep. 13, 2013, the entire contents of which are incorporated herein by reference.

### BACKGROUND

Security processors are used to perform a variety of operations with cryptographic keys, such as encrypting or decrypting data, generating keys, and so on. These security processors are often designed for particular applications for which the security processors will be deployed. For example, a security processor of a game console may include functionality to process game content in a secure manner, whereas a security processor of a set-top box may include hardware components to securely stream content. Since these security processors are designed for particular applications, it is often difficult and sometimes impossible to reconfigure the security processors for another purpose. Further, these security processors may require extensive time to design for particular applications. As an increasing number of devices seek to protect information, there is an increasing need to provide a secure environment for performing cryptographic operations.

### SUMMARY

This disclosure describes a security processing unit configured to manage cryptographic keys. In some instances, the security processing unit may comprise a co-processing unit that includes memory, one or more processors, and other components to perform operations in a secure environment. A central processing unit or another component that is external to the security processing unit may communicate with the security processing unit to cause the security processing unit to perform a variety of operations. For example, the security processing unit may generate a cryptographic key, configure access to a cryptographic key, provide a component of the computing device with access to a cryptographic key, encrypt/decrypt data with a cryptographic key, and so on. A cryptographic key may be associated with access rights indicating who may use the cryptographic key, how the cryptographic key may be used, and so on. The access rights may be specified by the security processing unit, the central processing unit, or another component of the computing device. The security processing unit may provide a secure environment to perform operations that are requested by the central processing unit or other component.

This Summary is provided to introduce a selection of concepts in a simplified form that are further described below in the Detailed Description. This Summary is not intended to identify essential features of the claimed subject matter, nor is it intended to be used to limit the scope of the claimed subject matter.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment in which techniques described herein may be implemented.

FIG. 2 illustrates examples details of a computing device that implements the techniques described herein.

FIG. 3 illustrates an example process for managing one or more cryptographic keys based on a command from a component of a computing device.

FIG. 4 illustrates an example process for creating a cryptographic key.

### DETAILED DESCRIPTION

This disclosure describes a security processing unit configured to manage cryptographic keys. In some instances, the security processing unit may comprise a co-processing unit that includes memory, one or more processors, and other components to perform operations in a secure environment. A component that is external to the security processing unit (also referred to as an “external component”) may communicate with the security processing unit to generate cryptographic keys, access cryptographic keys, encrypt/decrypt data with cryptographic keys, or otherwise utilize cryptographic keys. The external component may comprise a central processing unit, an application, and/or any other hardware or software component that is located outside the security processing unit.

In various embodiments, the security processing unit may manage cryptographic keys according to key data that describes access rights of the cryptographic keys. The key data may generally identify components that may utilize the cryptographic keys and/or how the cryptographic keys may be utilized. For example, the cryptographic keys may include keys that are only accessible to a central processing unit, keys that are only accessible to the security processing unit, and so on. When an unauthorized component seeks to access or otherwise utilize a cryptographic key that the unauthorized component is not authorized to access according to key data, the security processing unit may restrict the access to the cryptographic key. In some instances, the key data is specified by an external component, while in other instances the key data may be determined by the security processing unit.

The external component of the computing device may generally communicate with the security processing unit according to a set of commands. The external component may send a command to the security processing unit and the security processing unit may perform a requested operation. In many instances, an operation relates to a cryptographic key. For example, the external component may issue a command to generate a cryptographic key for storage within the security processing unit. The external component may specify, for example, a component that is authorized to access the cryptographic key, a destination location in memory to store the cryptographic key, another cryptographic key to utilize to generate the cryptographic key, and so on. In another example, the external component may issue a command to configure access to a cryptographic key or delete a cryptographic key that is located in a particular location in memory. In yet another example, the external component may issue a command to provide a cryptographic key to the external component. In other examples, the external component may issue commands to perform a variety of other operations.

In various embodiments, the security processing unit may provide a secure environment to maintain cryptographic keys and other information. By utilizing a set of commands and/or key data to manage the cryptographic keys, the security processing unit may provide a flexible architecture where the cryptographic keys may be distributed or otherwise utilized without compromising the cryptographic keys. Further, in some instances the security processing unit may be configured to manage the cryptographic keys without knowledge of an application or context in which the cryptographic key is being utilized by an external component. This type of configuration may allow the security processing unit to be deployed in a wide variety of implementations.

This brief introduction is provided for the reader's convenience and is not intended to limit the scope of the claims, nor the proceeding sections. Furthermore, the techniques described in detail below may be implemented in a number of ways and in a number of contexts. Example implementations and contexts are provided with reference to the following figures, as described below in more detail. It is to be appreciated, however, that the following implementations and contexts are only examples of many.

### Example Environment

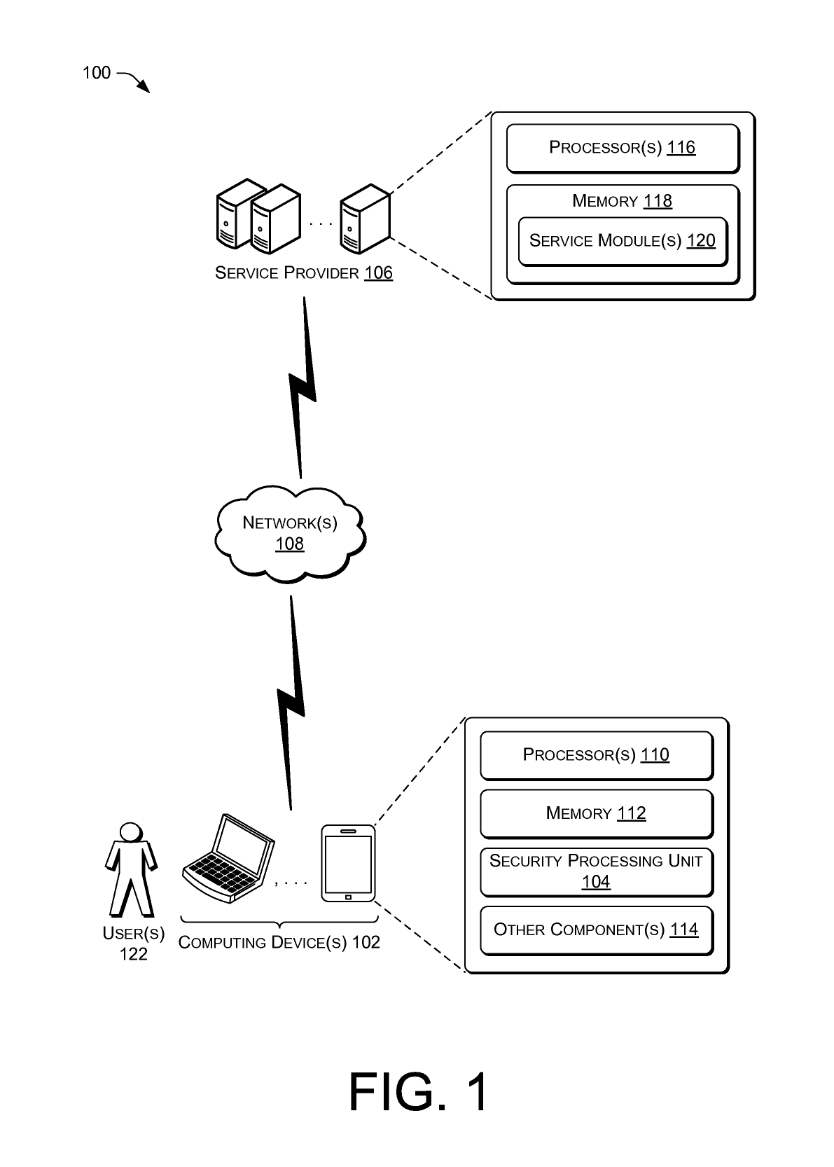

FIG. 1 illustrates an example environment 100 that is usable to implement the security processing unit described herein. The environment 100 includes one or more computing devices 102 (hereinafter “the computing device 102”) having a security processing unit 104 that manages one or more cryptographic keys and performs other cryptographic operations. The environment 100 also includes a service provider 106 to provide one or more services to the computing device 102. For example, the service provider 106 may perform an attestation process in which the service provider 106 identifies the computing device 102 and/or verifies a particular application state of the computing device 102. In various embodiments, the computing device 102 may communicate with the service provider 106 via one or more networks 108, such as the Internet, a Mobile Telephone Network (MTN), or other various communication technologies.

The computing device 102 may include, but is not limited to, any one of a variety of computing devices, such as a smart phone, a mobile phone, a personal digital assistant (PDA), an electronic book device, a laptop computer, a desktop computer, a tablet computer, a portable computer, a gaming device, a personal media player device, a server computer or any other electronic device.

The computing device 102 may include one or more processors 110 (hereinafter “the processor 110”) and memory 112. The processor 110 may be a single processing unit or a number of units, each of which could include multiple different processing units. The processor 110 may include one or more microprocessors, microcomputers, microcontrollers, digital signal processors, central processing units (CPUs), graphics processing units (GPUs), and/or other processors. In some instances, the processor 110 and memory 112 may comprise the main CPU and main memory, respectively, of the computing device 102.

As noted above, the computing device 102 may also include the security processing unit 104 to manage one or more cryptographic keys and perform other cryptographic operations. The security processing unit 104 may comprise one or more secure cryptoprocessing units or other types of processing units that are configured to perform cryptographic operations.

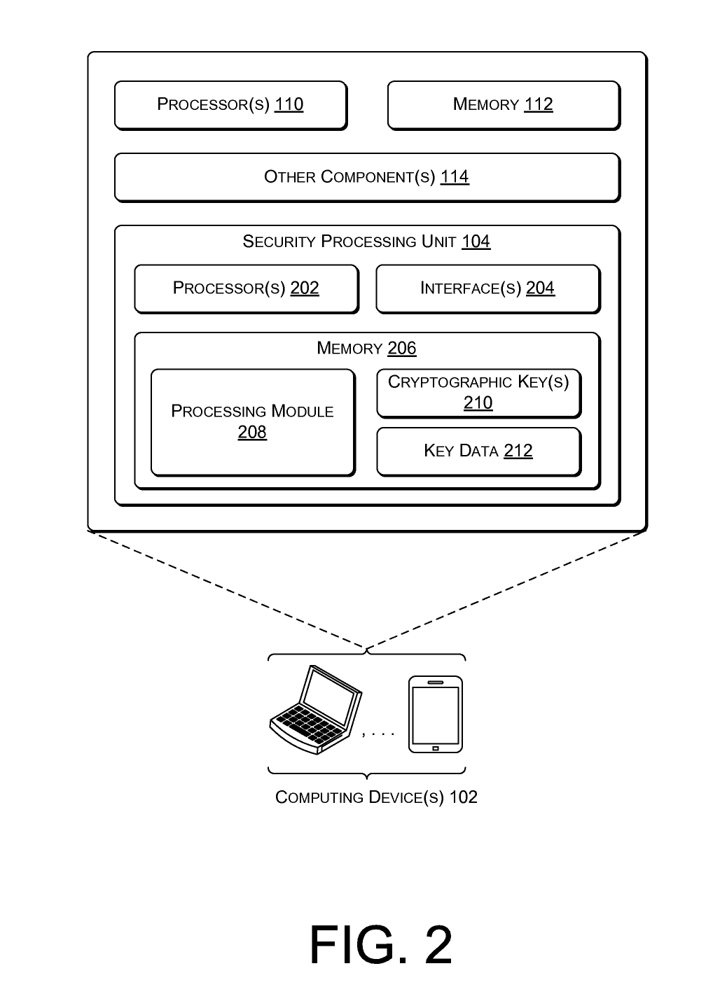

The security processing unit 104 may perform a variety of operations related to cryptographic keys. For example, the security processor processing unit 104 may generate, store, configure access to, delete, provide access to, and/or encrypt/decrypt data with a cryptographic key. The security processing unit 104 may generally manage the cryptographic keys for the processor 110, the memory 112, and/or one or more other components 114 (hereinafter “the other components 114”). Further details of the security processing unit 104 will be discussed in below in reference to FIG. 2.

The other components 114 may include any type of hardware and/or software components that may communicate with the security processing unit 104 either directly or indirectly (e.g., through the processor 110) to obtain a cryptographic key and/or cause the security processing unit 104 to perform an operation. For example, the other components 114 may include a video, audio, storage device interface, and/or memory coding engine configured to encrypt/decrypt content (e.g., a video, audio, image, etc.) with a cryptographic key that is provided by the security processing unit 104. In one example, a storage device interface coding engine may be incorporated into a hard-disk drive controller and may be configured to encrypt/decrypt data for a disk of a hard-disk drive. In instances where the other components 114 include software, the other components 114 may be stored as modules or other data structures within the memory 112. The processor 110, memory 112, security processing unit 104, and/or other components 114 may each represent a “component” of the computing device 102, while the processor 110, memory 112, and/or the other components 114 may each represent a component that is external to the security processing unit 104 (also referred to as an “external component”).

The service provider 106 may include one or more computing devices, such as one or more desktop computers, laptop computers, servers, and the like. The one or more computing devices may be configured in a cluster, data center, cloud computing environment, or a combination thereof. In one example, the one or more computing devices provide cloud computing resources, including computational resources, storage resources, and the like, that operate remotely from the computing device 102.

The one or more computing devices of the service provider 106 may include one or more processors 116 and memory 118. The one or more processors 116 may comprise a single processing unit or a number of units, each of which could include multiple different processing units. The one or more processors 116 may include, for example, one or more microprocessors, microcomputers, microcontrollers, digital signal processors, CPUs, GPUs, security processors (e.g., secure cryptoprocessors), etc.

The service provider 106 may include one or more service modules 120 stored in the memory 118 and executable by the one or more processors 116. As used herein, the term “module” is intended to represent example divisions of software and/or firmware for purposes of discussion, and is not intended to represent any type of requirement or required method, manner or organization. Accordingly, while various “modules” are discussed, their functionality and/or similar functionality could be arranged differently (e.g., combined into a fewer number of modules, broken into a larger number of modules, etc.). Further, while certain functions are described herein as being implemented as software and/or firmware modules configured for execution by a processor, in other embodiments, any or all of the functions may be implemented (e.g., performed) in whole or in part by hardware logic components. For example, and without limitation, illustrative types of hardware logic components that can be used include Field-programmable Gate Arrays (FPGAs), Application-specific Integrated Circuits (ASICs), Application-specific Standard Products (ASSPs), state machines, Complex Programmable Logic Devices (CPLDs), other logic circuitry, systems on chips (SoCs), and/or any other devices that perform operations based on software and/or hardware coded instructions. Among other capabilities, the one or more processors 116 may be configured to fetch and/or execute computer-readable instructions stored in the memory 118.

The one or more service modules 120 may be configured to perform one or more services for the computing device 102 and/or other devices. In one example, the one or more service modules 120 may perform an attestation process in which the computing device 102 communicates with the service provider 106 to identify the computing device 102 and/or verify a particular application state (e.g., a safe state that is not compromised, tampered with, subjected to malware, etc.). In another example, the one or more service modules 120 may assist the computing device 102 in encrypting and/or decrypting data. Additionally, or alternatively, the one or more service module 120 may store any number of cryptographic keys (e.g., for an attestation process or otherwise) and/or perform a variety of other operations.

The environment 100 also includes one or more users 122 to employ the computing device 102. The one or more users 122 may interact with the computing device 102 to perform a variety of operations.

### Example Computing Device

FIG. 2 illustrates examples details of the computing device 102 of FIG. 1. In this example, the security processing unit 104 is equipped with one or more processors 202 (hereinafter “the processor 202”), one or more interfaces 204 (hereinafter “the interface 204”), and memory 206. The processor 202 may comprise one or more secure cryptoprocessors, microprocessors, microcomputers, microcontrollers, digital signal processors, central processing units (CPUs), graphics processing units (GPUs), and/or other processors. The interface 204 may communicate with components of the computing device 102 that are external to the security processing unit 104, such as the processor 110, memory 112, and/or other components 114. In some instances, the interface 204 includes one or more buffers or registers to facilitate the communication.

In the example of FIG. 2, the functionality of the security processing unit 104 is facilitated by a processing module 208. The processing module 208 may include executable instructions (e.g., code) that, when executed by the processor 202, carry out the operations of the security processing unit 104. Here, the processing module 208 may be stored in the memory 206. Although, in other examples, such as when the security processing unit 104 is not implemented as the processor 202 and executable instructions, the processing module 208 may be stored elsewhere or eliminated entirely. Further, in some instances the security processing unit 104 may be implemented as dedicated hardware logic, such as a system on a chip (SoC), microprocessor, Field-programmable Gate Array (FPGA), Application-specific Integrated Circuit (ASIC), Application-specific Standard Product (ASSP), state machine, Complex Programmable Logic Device (CPLD), other logic circuitry or dedicated device. As such, in some instances the security processing unit 104 may not include modules (e.g., the processing module 208), the processor 202, and/or the interface 204, and functionality of the security processing unit 104 may be implemented by the dedicated hardware logic.

The processing module 208 may be configured to manage one or more cryptographic keys 210 (hereinafter “the cryptographic keys 210”) based on key data 212 that describes access permission to the cryptographic keys 210. The cryptographic keys 210 may include identity keys (e.g., used during an attestation process), encryption/decryption keys (e.g., for encrypting/decrypting data), hardware keys (e.g., used to access hardware components), and/or any other type of cryptographic key. In some instances, the cryptographic keys 210 may include keys that may not be deleted and/or accessed, except when particular events occur, such as a reset (rebooting) of the computing device 102. Further, in some instances the cryptographic keys 210 may include keys that are available during part of a boot cycle. For example, some keys might be available early during a boot cycle and deleted or otherwise made inaccessible before the system is fully booted, or keys might be available during the normal operations of the system and deleted or otherwise made inaccessible when the system is restarted.

The key data 212 (sometimes referred to as “key type data”) may include one or more key control parameters controlling the cryptographic keys 210. The key control parameters may include, for example:
An export control parameter (sometimes referred to as “virtualizable”) that indicates whether or not a cryptographic key may be exported (e.g., is exportable) from the security processing unit 104 in an encrypted form (e.g., may be provided to a component that is external to the security processing unit 104 in an encrypted form). In some instances, such as when key register virtualization is occurring, it may be beneficial to export a cryptographic key from the security processing unit 104 in an encrypted form. Key register virtualization may move a cryptographic key from a register or other volatile memory of the security processing unit 104 to main memory, such as the memory 112, and return the cryptographic key to the register when it is needed by the security processing unit 104. This may allow the security processing unit 104 to overcome a limited number of registers or other volatile memory.
An owner control parameter (sometimes referred to as “key owner”) that identifies one or more components that may access a cryptographic key. In other words, the owner control parameter specifies an owner of the cryptographic key that has access rights to the cryptographic key (e.g., is authorized to access the cryptographic key). To illustrate, if an owner control parameter for a cryptographic key indicates that the central processing unit of the computing device 102 is the owner, then the cryptographic key may be provided to or otherwise accessed by the central processing unit. In another illustration, if an owner control parameter for a key indicates that the security processing unit 104 is the only owner, then the cryptographic key may not be sent outside the security processing unit 104 and/or utilized by a component that is external to the security processing unit 104.
A key usage control parameter (sometimes referred to as “key usage”) that specifies how a cryptographic key may be used. For example, the key usage control parameter may specify that a cryptographic key may be used for generating another cryptographic key (e.g., using a key derivation function (KDF)), encrypting/decrypting data, and so on. Further, in some examples the key usage control parameter may specify that a cryptographic key may not be used for any operations. In yet a further example, the key usage control parameter may specify a cryptographic algorithm or type of algorithm for which a cryptographic key may be used.

In various embodiments, the memory 206 may include non-volatile storage, such as a set of fuses, registers, and/or other types of non-volatile memory to store information (e.g., the cryptographic keys 210, values, commands, and so on). A set of fuses or registers may be referred to as a fuse or register bank. A fuse may generally include a hardware component that may store information in a permanent manner (e.g., in a write-once manner—once a value is stored, the value cannot be overwritten). A fuse may comprise a wire that may be “burned-out” by causing a threshold amount of electric current to flow through the wire. A fuse that is “burned-out” may be associated with a broken conductive path. A single fuse may store one bit of information. As such, multiple fuses may be used to store a single cryptographic key. In some instances, a cryptographic key may be stored in fuses or a register along with key data that is specific to the cryptographic key. That is, each cryptographic key may be stored along with its own key data.

The security processing unit 104 may be configured to prevent the cryptographic keys 210 from being read by components that are external to the security processing unit 104. That is, the security processing unit 104 may maintain the cryptographic keys 210 in a secured manner so that other components of the computing device 102 may not directly access the cryptographic keys 210. To access or otherwise utilize a cryptographic key, the external component may be required to communicate with the security processing unit 104. If the external component is authorized to access or utilize the requested cryptographic key, the security processing unit 104 may obtain (e.g., read) the cryptographic key from the memory 206 and perform a requested operation (e.g., send the cryptographic key to the external component via the interface 204, generate a new cryptographic key, etc.). As such, the memory 206 (e.g., including non-volatile storage) may be not be read by components of the computing device 102 that are external to the security processing unit 104.

The processing module 208 of the security processing unit 104 may generally operate according to a set of commands. A component that is external to the security processing unit 104, such as the processor 110, memory 112, and/or other components 114, may send a command to the security processing unit 104 requesting that the security processing unit 104 perform an operation. As noted above, the command may be sent to the interface 204, which communicates with components that are external to the security processing unit 104. In some instances, the processing module 208 may determine whether or not the component is authorized to cause such an operation to be performed. To illustrate, if the command identifies a cryptographic key with which to perform the operation, the processing module 208 may reference key data for the cryptographic key to determine if the component is authorized to access the cryptographic key. If the component is authorized, then the processing module 208 may proceed with performance of the operation requested in the command. If the component is not authorized, then such operation may not be performed. Example commands include:
A key retrieval command (sometimes referred to as “GetKey” or “SendKey”) requesting the security processing unit 104 to provide a particular cryptographic key that is stored in the memory 206 to a component that is external to the security processing unit 104, such as a component that sent the command or another component. The cryptographic key may be sent if the component to which the cryptographic key is to be sent and/or component that sent the request is authorized to utilize/access the cryptographic key. This may be determined by referencing key data for the cryptographic key. In some instances, a particular cryptographic key may not be provided outside the security processing unit 104 (e.g., “KeyEncEphemeral” or “KeyEncFused”).
A key move command (sometimes referred to as “ReadFusedKey” or “WriteFusedKey”) requesting the security processing unit 104 to move a cryptographic key from one location in the memory 206 to another location in the memory 206. This may include reading a cryptographic key from source fuses or a source register and storing the cryptographic key in destination fuses or a destination register. The command may specify the source fuses or register and/or the destination fuses or register. In some instances, a particular source or destination register or fuses may not be used. For example, a particular type of key (e.g., “KeyEncEphemeral” or “KeyEncFused”) may not be moved from fuses.
A key storage command (sometimes referred to as “SetKey”) requesting the security processing unit 104 to store a specified value as a cryptographic key in the memory 206. Here, the command may specify (e.g., identify) the value to be set for the cryptographic key, a register or fuses to set (e.g., a register or fuses in which to store the cryptographic key), and/or key data to be associated with the cryptographic key. In some instances, a particular register or fuses may not be set by this command (e.g., a register or fuses that includes “KeyEncEphemeral” or “KeyEncFused”).
A key deletion command (sometimes referred to as “WipeRegister”) requesting the security processing unit 104 to delete (e.g., wipe) a cryptographic key stored in the memory 206 or otherwise make the cryptographic key inaccessible. This may include setting a register that includes the cryptographic key to zero. The command may identify the particular cryptographic key to delete. In some instances when a cryptographic key is deleted from a register, the key data for the register may be set so that the register is not exportable, the key owner is the security processing unit 104, and/or the register is not usable. In some instances, a particular cryptographic key may not be deleted (e.g., “KeyEncEphemeral” or “KeyEncFused”), except during a reset/boot of the computing device 102 as discussed below. As such, some keys may remain active during a boot cycle.
A key data configuration command (sometimes referred to as “LockFuses”) requesting the security processing unit 104 to configure key data of a cryptographic key. Here, the security processing unit 104 may update or otherwise configure key control parameters to an export control parameter, owner control parameter, and/or key usage control parameter that is provided in the command. In one example, this command may specify a number of registers or fuses to lock so that cryptographic keys that are stored in those registers or fuses may not be accessed. The registers or fuses may be unlocked when a reset/boot occurs.
A key generation command (sometimes referred to as “GenerateRandomKey” or “KDF”) requesting the security processing unit 104 to generate a cryptographic key. In one example, the command may request that a random value be generated to be used for the cryptographic key. Here, the command may specify key data to be associated with the cryptographic key (e.g., an owner of the key that is authorized to access the key, etc.). The random value for the cryptographic key may be generated by the security processing unit 104. In another example, a key generation command may request that a KDF or other one-way function be utilized to derive a cryptographic key. Here, the command may also specify another cryptographic key to utilize to derive the cryptographic key (e.g., a location of the other cryptographic key in memory). If the component that sent the command is not authorized to access the other cryptographic key, then the cryptographic key may not be generated. In this later example, the command may also include a key creation parameter (sometimes referred to as “KDF parameter”) to utilize as an input to the KDF or other one-way function. At least a portion of the key creation parameter may include key data to be associated with the new cryptographic key. In either example, the command may specify a location in the memory 206 to store the generated cryptographic key (e.g., particular fuses or a register). In some examples, a particular register or set of fuses may not be used by this command to obtain a cryptographic key for a derivation and/or to store a resulting cryptographic key (e.g., a register or set of fuses that includes “KeyEncEphemeral” or “KeyEncFused”).
An encryption command (sometimes referred to as “Encrypt”) requesting the security processing unit 104 to encrypt data. The command may identify a particular cryptographic key to utilize to encrypt the data. In some instances, the command may provide the data to encrypt, while in other instances the command may identify where the data is located (e.g., a register or fuses of the memory 206). The security processing unit 104 may store the encrypted data and/or output the encrypted data to the component that sent the command and/or another component. In some examples when a cryptographic key is being encrypted (e.g., during key register virtualization), the security processing unit 104 may first verify that the cryptographic key is exportable in an encrypted form (e.g., virtualizable). In some examples, a particular cryptographic key may not be encrypted (e.g., “KeyEncEphemeral” or “KeyEncFused”).
A decryption command (sometimes referred to as “Decrypt”) requesting the security processing unit 104 to decrypt data. The command may identify the cryptographic key to utilize to decrypt the data, where the encrypted data is located (e.g., in a register or fuses of the memory 206), and/or where to store the decrypted data. Although in some instances the encrypted data may be provided by a component that sent the command. In some examples, a particular register or fuses may not be used by this command to store decrypted data (e.g., a register or fuses that includes “KeyEncEphemeral” or “KeyEncFused”).
A reset command (sometimes referred to a “Reset”) requesting the security processing unit 104 to reset or delete all cryptographic keys in the memory 206 or a particular number of cryptographic keys. This command may be sent each time the computing device 102 is booted. Once the cryptographic keys are deleted, the security processing unit 104 may generate a base set of keys to be utilized by the computing device 102, such as a key hierarchy that may be utilized for attestation, a hardware component, and/or encryption. The security processing unit 104 may also generate keys that may exist for that boot cycle (e.g., “KeyEncEphemeral”).
A get information command (sometimes referred to as “GetInformation”) requesting that the security processing unit 104 provide information about the characteristics of the security processing unit 104, such as a version number, a product line identifier, a model number, a number of registers or fuses that are included in the security processing unit 104, a type of KDF or encryption/decryption algorithm that may be utilized, and so on. In some instances, the get information command may be useful when the security processing unit 104 is updated to include new characteristics.

In one illustration of a key generation command (e.g., “KDF”), the security processing unit 104 receives a command to generate a cryptographic key with a KDF or other one-way function. The command may identify a source location of another cryptographic key to use to create the cryptographic key and a destination location to store the cryptographic key. The command may also include a key creation parameter. The key creation parameter may have been generated by a component that is external to the security processing unit 104, such as a central processing unit or other component. A portion of the key creation parameter may include key data. Another portion of the key creation parameter may include a value (e.g., number, random value, other value, etc.). The security processing unit 104 may derive the cryptographic key by inputting the cryptographic key identified in the command (e.g., the other cryptographic key) and the key creation parameter of the command into the KDF or other one-way function. The KDF or other one-way function may output the cryptographic key, which may then be stored into the destination location identified in the command. The security processing unit 104 may set key data for the newly created cryptographic key to (i) the key data that is a part of the key creation parameter or (ii) a value that is derived from the key creation parameter (e.g., the key data for the newly created cryptographic key may be a function of the key creation parameter). Thus, in some instances the input to the KDF or other one-way function may include the key data (e.g., access control information for the newly created cryptographic key).

Although the security processing unit 104 is illustrated in the example of FIG. 2 as including the processors 202, interface 204, and memory 206, in other examples the security processing unit 104 may be implemented in whole or in part by the processor 110, memory 112, and/or other components 114.

The memory 112, 118, 206, and/or all other memory described herein may include one or a combination of computer-readable media. As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes, but is not limited to, phase change memory (PRAM), static random-access memory (SRAM), dynamic random-access memory (DRAM), other types of random access memory (RAM), read only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media includes computer-readable instructions, data structures, program modules, or other data in a modulated data signal, such as a carrier wave. As defined herein, computer storage media does not include communication media.

### Example Processes

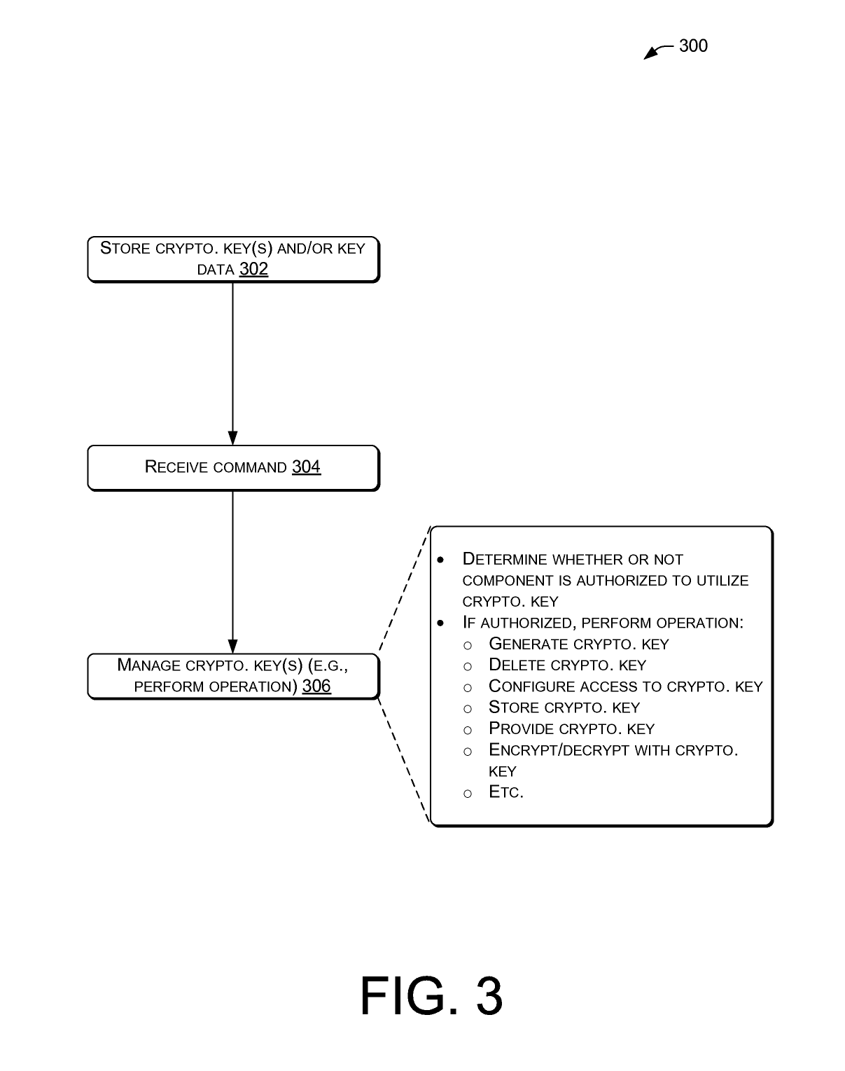

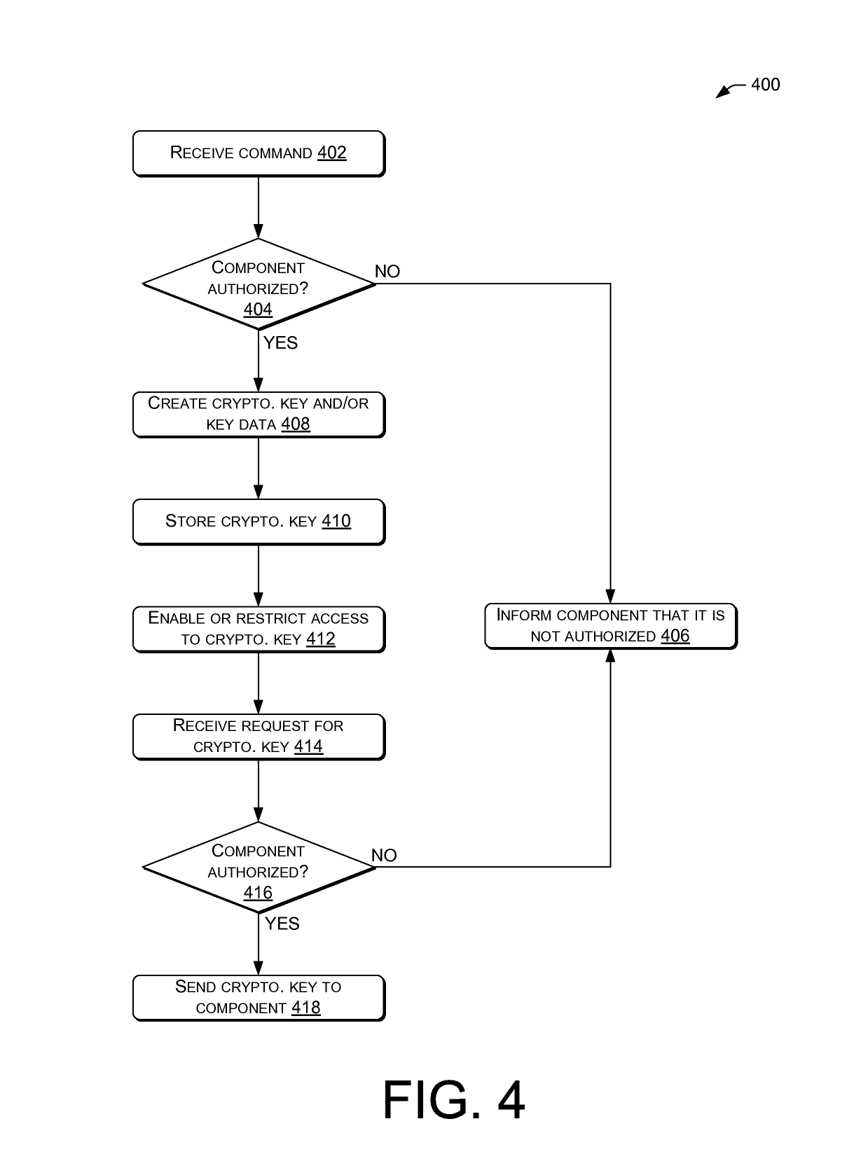

FIGS. 3 and 4 illustrate example processes 300 and 400 for employing the techniques described herein. For ease of illustration the processes 300 and 400 are described as being performed in the environment 100 of FIG. 1. For example, one or more of the individual operations of the processes 300 and 400 may be performed by the computing device 102 and/or the service provider 106. In particular, one or more of the individual operations of the processes 300 and 400 may be performed by the security processing unit 104. However, the processes 300 and 400 may be performed in other environments. Moreover, the environment 100 may be used to perform other processes.

The processes 300 and 400 (as well as each process described herein) are illustrated as a logical flow graph, each operation of which represents a sequence of operations that can be implemented in hardware, software, or a combination thereof. In the context of software, the operations represent computer-executable instructions stored on one or more computer-readable media that, when executed by one or more processors, configure the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Further, any of the individual operations may be omitted.

FIG. 3 illustrates the example process 300 to manage one or more cryptographic keys based on a command from a component of a computing device.

At 302, the security processing unit 104 may store one or more cryptographic keys within the memory 206 of the security processing unit 104 and/or key data describing access permission (e.g., rights) to the one or more cryptographic keys. In some instances, the one or more cryptographic keys and/or key data may be stored within one or more fuses or registers of the memory 206.

At 304, the security processing unit 104 may receive a command from a component of the computing device 102 (e.g., a component of a computing device in which the security processing unit 104 is incorporated). For instance, the command may be received from the processor 110 and/or other components 114 that are external to the security processing unit 104. The command may be received by the interface 204 of the security processing device 104. The command may request that the security processing unit 104 perform an operation related to the one or more cryptographic keys, such as providing a cryptographic key, configuring access to a cryptographic key, encrypt/decrypt data with a cryptographic key, deleting a cryptographic key, and so on. In one example, a central processing unit of the computing device 102 provides the command to the security processing unit 104.

At 306, the security processing unit 104 may manage the one or more cryptographic keys based on the command and/or the key data. In some instances, the managing may include determining whether or not the component that sent the command is authorized to utilize the one or more cryptographic keys based on the key data. The managing may also include performing the operation requested in the command in response to determining that the component is authorized to utilize the one or more cryptographic keys.

To illustrate, the security processing unit 104 may generate a cryptographic key based on a key control parameter that is provided in the command. A key control parameter may include an owner control parameter identifying an owner of a cryptographic key, an export control parameter indicating whether or not a cryptographic key is exportable from the security processing unit 104, and/or a key usage control parameter that specifies how a cryptographic key may be used. In some instances a cryptographic key may be generated with a key derivation function (KDF) or other one-way function. The KDF may utilize another cryptographic key, which may be identified in a command, to derive the cryptographic key.

In other illustrations, the security processing unit 104 may delete a cryptographic key, configure key data for a cryptographic key (e.g., restricting or enabling access to the cryptographic key), store a cryptographic key in the memory 206 (e.g., in fuses or a register that is identified in the command), provide a cryptographic key to a component that sent the request and/or another component, encrypt or decrypt data with a cryptographic key, provide encrypted or decrypted data to a component, and so on.

FIG. 4 illustrates the example process 400 for creating a cryptographic key.

At 402, the security processing unit 104 may receive a command to create a cryptographic key. The command may be received from a component of a computing device 102, such as the processor 110 (e.g., central processing unit) and/or other components 114 (e.g., an application executing on the computing device 102). In some instances, the command may request that the cryptographic key be created with a KDF or other one-way function. In these instances, the command may identify a source location of another cryptographic key to use to create the cryptographic key and a destination location to store the cryptographic key. The command may also include a key creation parameter (e.g., value) to be used as input to a KDF or other one-way function. At least a portion of the key creation parameter may include key data to be associated with the cryptographic key once created.

At 404, the security processor 104 may determine whether or not the component from which the command is received is authorized to access the other cryptographic key that is to be utilized to create the cryptographic key. This may include referencing key data for the other cryptographic key to determine if the component has access rights.

In response to determining that the component is not authorized, the process 400 may proceed to 406 (e.g., the NO branch) and inform the component that it is not authorized to access the other key. Alternatively, if it is determined that the component is authorized, the process 400 may proceed to 408 (e.g., the YES branch).

At 408, the security processing unit 104 may create the cryptographic key (e.g., a new cryptographic key) and/or key data for the cryptographic key. The cryptographic key may be created with a KDF or other one-way function based on the key creation parameter provided by the command and the other cryptographic key identified by the command (e.g., an existing cryptographic key). That is, the cryptographic key may be derived with the KDF or other one-way function with inputs including the key creation parameter provided by the command and the other cryptographic key. The KDF or other one-way function may output the cryptographic key. The key data may be created based on information in the command. For example, the key data for the newly created cryptographic key may be set to the key data that forms part of the key creation parameter.

At 410, the security processing unit 104 may store the created cryptographic key within the security processing unit 104, such as within a register or fuses of the memory 206. The cryptographic key may be stored at a destination location that is specified in the command (e.g., a particular register or fuses).

At 412, the security processing unit 104 may enable or restrict access to the cryptographic key based on the key data for the cryptographic key. That is, the security processing unit 104 may enable access to the cryptographic key for a component that is authorized in the key data and may restrict access to the cryptographic key for another component of the computing device 102 that is not authorized in the key data. The component to which access is enabled may include the component from which the command is received, the security processing unit 104, and/or another component of the computing device 102.

At 414, the security processing unit 104 may receive a request from a component of the computing device 102 to access a cryptographic key. The request may request that the cryptographic key be provided to the requesting component and/or another component.

At 416, the security processing unit 104 may determine whether or not the component is authorized to access the cryptographic key based on the key data for that cryptographic key.

In response to determining that the component is not authorized to access the cryptographic key, the process 400 may proceed to 406 (e.g., the NO path) and inform the component that it is not authorized to access the cryptographic key. Alternatively, in response to determining that the component is authorized, the process 400 may proceed to 418 (e.g., the YES path), where the cryptographic key is sent to the component as a response to the request.

### CONCLUSION

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A security processing unit comprising:
one or more processors;
memory communicatively coupled to the one or more processors and configured to store one or more cryptographic keys and key data describing access permission to the one or more cryptographic keys, the security processing unit being configured to prevent the one or more cryptographic keys from being read by a central processing unit;
an interface communicatively coupled to the one or more processors and configured to receive a command from the central processing unit regarding generation of a new cryptographic key, the command including a key creation parameter; and
a processing module executable by the one or more processors to:
manage the one or more cryptographic keys based at least in part on the key data of the one or more cryptographic keys;
generate the new cryptographic key based at least in part on the key creation parameter and the one or more cryptographic keys, the new cryptographic key being generated with a key derivation function or other one-way function; and
generate key data for the new cryptographic key based on at least a portion of the key creation parameter.

2. The security processing unit of claim 1, wherein the memory includes non-volatile memory that includes at least one of one or more registers or a set of fuses to store the one or more cryptographic keys.

3. The security processing unit of claim 1, wherein the processing module is configured to:
manage the one or more cryptographic keys by determining whether or not the central processing unit is authorized to utilize the one or more cryptographic keys based at least in part on the key data of the one or more cryptographic keys; and
generate the new cryptographic key when it is determined that the central processing unit is authorized to utilize the one or more cryptographic keys.

4. The security processing unit of claim 1, wherein:
the at least the portion of the key creation parameter that is utilized to generate the key data for the new cryptographic key includes key data; and
the key data for the new cryptographic key includes at least one of the key data of the of the key creation parameter or a value that is derived from the key creation parameter.

5. The security processing unit of claim 1, wherein the key data of the new cryptographic key includes at least one of an owner control parameter identifying an owner of the new cryptographic key, an export control parameter indicating whether or not the new cryptographic key is exportable from the security processing unit, or a key usage control parameter specifying usage of the new cryptographic key.

6. The security processing unit of claim 1, wherein the processing module is configured to manage the one or more cryptographic keys by at least one of deleting a cryptographic key of the one or more cryptographic keys, configuring key data for a cryptographic key of the one or more cryptographic keys, storing a cryptographic key of the one or more cryptographic keys in the memory, providing a cryptographic key of the one or more cryptographic keys to the central processing unit, or encrypting or decrypting data with a cryptographic key of the one or more cryptographic keys.

7. One or more computer-readable media storing computer-executable instructions, the computer-executable instructions upon execution, to instruct a security processing unit to perform operations comprising:
receiving, from a component of a computing device that incorporates the security processing unit, a command to create a cryptographic key, the command including a key creation parameter;
creating the cryptographic key based at least in part on the key creation parameter;
creating key data for the cryptographic key based on at least a portion of the key creation parameter, the key data describing access permission to the cryptographic key;
storing the cryptographic key within the security processing unit; and
based at least in part on the key data of the cryptographic key, enabling access to the cryptographic key by a particular component of the computing device and restricting access to the cryptographic key by another component of the computing device.

8. The one or more computer-readable media of claim 7, wherein the component from which the command is received comprises at least one of a central processing unit of the computing device or an application that is executing on the computing device.

9. The one or more computer-readable media of claim 7, wherein the particular component to which access is enabled comprises at least one of the component from which the command is received, the security processing unit, or a further component of the computing device.

10. The one or more computer-readable media of claim 7, wherein:
the command specifies a destination location to store the cryptographic key within the security processing unit; and
the cryptographic key is stored at the destination location that is specified in the command.

11. The one or more computer-readable media of claim 7, wherein:
the command identifies another cryptographic key; and
the cryptographic key is created with a key derivation function or other one-way function based at least in part on the other cryptographic key.

12. The one or more computer-readable media of claim 11, wherein the operations further comprise:
determining that the component from which the command is received is authorized to access the other cryptographic key; and
wherein the cryptographic key is created upon determining that the component from which the command is received is authorized to access the other cryptographic key.

13. The one or more computer-readable media of claim 7, wherein the operations further comprise:
after enabling or restricting access to the cryptographic key, receiving a request for the cryptographic key from the particular component of the computing device;
determining that the particular component is authorized to access the cryptographic key based at least in part on the key data of the cryptographic key; and
sending the cryptographic key to the particular component in response to the determining.

14. A security processing unit comprising:
one or more processors;
an interface communicatively coupled to the one or more processors and configured to receive a command from a component that is external to the security processing unit, the command requesting that the security processing unit derive a new cryptographic key with a key creation parameter;
a processing module executable by the one or more processors to:
read a cryptographic key from non-volatile memory;
derive the new cryptographic key with a key derivation function or other one-way function based at least in part on the key creation parameter and the cryptographic key that is read from the non-volatile memory; and
cause the new cryptographic key to be stored in memory of the security processing unit or to be sent to at least one of the component that is external to the security processing unit or another component that is external to the security processing unit.

15. The security processing unit of claim 14, wherein:
the processing module is further configured to determine that the component that is external to the security processing unit is authorized to utilize the cryptographic key to derive the new cryptographic key; and
the processing module is configured to derive the new cryptographic key in response to determining that the component is authorized to utilize the cryptographic key.

16. The security processing unit of claim 14, wherein:
the memory of the security processing unit includes the non-volatile memory, the non-volatile memory comprising at least one of a set of fuses or a set of registers;
the command identifies at least one of the set of fuses or a register of the set of registers in which to store the new cryptographic key; and
the processing module is configured to store the new cryptographic key in at least one of the set of fuses or the register that is identified in the command.

17. The security processing unit of claim 14, wherein the processing module is configured to send the new cryptographic key to at least one of the component that is external to the security processing unit or the other component that is external to the security processing unit.

18. The security processing unit of claim 14, wherein:
the interface is further configured to receive a command requesting that key data of at least one of the new cryptographic key or the cryptographic key be configured; and
the processing module is further configured to configure the key data of at least one of the new cryptographic key or the cryptographic key by restricting or enabling access to the new cryptographic key or the cryptographic key.

19. The security processing unit of claim 14, wherein:
the interface is further configured to receive a command requesting that data be encrypted or decrypted with at least one of the new cryptographic key or the cryptographic key; and
the processing module is further configured to encrypt or decrypt the data with at least one of the new cryptographic key or the cryptographic key and to provide the encrypted or decrypted data.

20. The security processing unit of claim 14, wherein:
the interface is further configured to receive a command requesting that the cryptographic key be deleted; and
the processing module is further configured to delete the cryptographic key from the non-volatile memory.
